(19) United States
(12) Patent Application Publication
(10) Pub. No.: US 2021/0231366 A1
(43) Pub. Date: Jul. 29, 2021

(54) SYSTEM AND METHOD FOR RECONDENSING BOIL-OFF GAS FROM A LIQUEFIED NATURAL GAS TANK

(71) Applicant: Air Products and Chemicals, Inc., Allentown, PA (US)

(72) Inventors: Mark Julian Roberts, Kempton, PA (US); Fei Chen, Whitehouse Station, NJ (US)

(73) Assignee: Air Products and Chemicals, Inc., Allentown, PA (US)

(21) Appl. No.: 16/750,534

(22) Filed: Jan. 23, 2020

(51) Int. Cl. F25J 1/00; F25J 1/02

(52) U.S. Cl. CPC F25J 1/0025; F25J 1/0205; F25J 1/0072

(57) ABSTRACT

Systems and methods are described for increasing capacity and efficiency of a nitrogen refrigerant boil-off gas recovery system for a natural gas storage tank. Boil-off gas is condensed against two-phase nitrogen in a condensing heat exchanger having an inner vessel through which the boil-off gas flows and an outer vessel through which the two phase nitrogen flows. Logic controls maintain storage tank pressure and power consumption within preferred levels by adjusting the pressure of the two-phase nitrogen in the heat exchanger. Additional logic controls maintain the temperature difference between the nitrogen streams entering into and returning from the cold end of a second heat exchanger by controlling the position of an expansion valve on the return circuit.

### BACKGROUND

The present invention relates to a process for recovering liquefied natural gas (LNG) boil-off (BOG) from a storage vessel (also referred to as a storage tank).

In ocean tankers carrying cargoes of liquid natural gas (LNG), as well as land based storage tanks, a portion of the liquid is lost through evaporation as a result of heat leak through the insulation surrounding the LNG storage receptacle. Moreover, heat leakage into LNG storage containers on both land and sea causes some of the liquid phase to vaporize thereby increasing the container pressure. Regulations prohibiting tanker disposal of hydrocarbon-containing streams by venting or flaring within the vicinity of metropolitan areas coupled with an increased desire to conserve energy costs have led to incorporation of reliquefiers into the design of new tankers for recovering LNG BOG .

One existing approach to BOG reliquification has been the use of a compression cycle, in which the BOG is compressed to an elevated pressure, cooled, and expanded before being returned to the storage vessel. The equipment required to compress the BOG is large, which is not ideal on tanker or other floating applications due to space contraints. In addition, the BOG is circulated through portions of the system at high pressure, which creates an elevated risk of leaks of flammable gas.

U.S. Pat. No. 4,843,829 describes an LNG BOG reliquefication process in which the predominantly methane BOG is compressed, then cooled sensibly by gaseous nitrogen in a closed loop nitrogen recycle refrigeration process, then condensed using boiling liquid nitrogen.

U.S. Pat. No. 6,192,705 describes an LNG boil-off gas reliquification process in which boil-off gas is condensed in an open loop methane refrigeration cycle where boil-off gas is warmed, compressed, cooled with ambient cooling then flashed to a low pressure to form liquid. In this case the BOG is warmed to ambient temperature before being compressed and cooled.

There is a need for an improved BOG liquification system that is capable of reliquifying BOG without the need for compressing the BOG or the need to subcool the BOG.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Several aspects of the systems and methods are outlined below.

Aspect 1: A method for re-condensing a boil-off gas stream comprising natural gas from a storage tank, the method comprising:

(a) at least partially condensing the boil-off gas stream in a first heat exchanger against a two phase refrigerant stream to form an at least partially condensed boil-off gas stream and a gaseous refrigerant stream, the two phase refrigerant stream comprising no more than 5 mol % hydrocarbons and at least 90 mol % of at least one selected from the group of nitrogen and argon, the two-phase refrigerant stream having a gas phase portion and a liquid phase portion in the first heat exchanger;

(b) returning the at least partially condensed boil-off gas stream to the storage tank;

(c) heating the gaseous refrigerant stream in a second heat exchanger against a high pressure refrigerant stream to form a warmed refrigerant stream;

(d) compressing the warmed refrigerant stream in a compression system to form a compressed refrigerant stream;

(e) cooling the compressed refrigerant stream in a third heat exchanger to form the high pressure refrigerant stream;

(f) cooling the high pressure refrigerant stream against the gaseous refrigerant stream in the second heat exchanger to form a high pressure cooled refrigerant stream;

(g) separating the high pressure cooled refrigerant stream into a first portion and a second portion;

(h) expanding the second portion of the high pressure cooled refrigerant stream to form an expanded refrigerant stream.

Aspect 2: The method of Aspect 1, further comprising:

(i) combining the expanded refrigerant stream with the gaseous refrigerant stream before performing at least a portion of step (c).

Aspect 3: The method of Aspect 2, wherein step (i) further comprises combining the expanded refrigerant stream with the gaseous refrigerant stream and a portion of the cooled refrigerant stream before performing step (c).

Aspect 4: The method of any of Aspects 1-3, wherein step (a) further comprises at least partially condensing the boil-off gas stream in the first heat exchanger at a substantially constant temperature against the two phase refrigerant stream to form the at least partially condensed boil-off gas stream and the gaseous refrigerant stream.

Aspect 5: The method of any of Aspects 1-4, further comprising:

(j) maintaining the boil-off gas at a pressure that is no more than 110% of a pressure of the storage tank during the performance of steps (a) and (b).

Aspect 6: The method of any of Aspects 1-5, wherein step (a) further comprises at least partially condensing the boil-off gas stream in a first vessel of the first heat exchanger against the two phase refrigerant stream flowing through a second vessel to form the at least partially condensed boil-off gas stream and the gaseous refrigerant stream, the first vessel being contained within the second vessel.

Aspect 7: The method of any of Aspects 1-6, wherein the two phase refrigerant stream comprises at least 99% nitrogen.

Aspect 8: The method of any of Aspects 1-7, further comprising:

(k) using energy recovered from the performance of step (h) to drive at least a portion of the compression system or a generator.

Aspect 9: The method of any of Aspects 1-8, wherein step (i) comprises combining the expanded refrigerant stream with the gaseous refrigerant stream after a portion of the cooling of step (c) has been performed on the gaseous refrigerant stream.

Aspect 10: The method of any of Aspects 1-9, further comprising:

(l) condensing a natural gas stream against the gaseous refrigerant stream in the second heat exchanger.

Aspect 11: The method of any of Aspects 1-10, further comprising:

(m) providing a blower that results in increased flow of the boil-off gas stream through the condensing heat exchanger.

Aspect 12: The method of any of Aspects 1-11, wherein step (a) comprises at least partially condensing the boil-off gas stream in the first heat exchanger located within a head space of the storage tank against the two phase refrigerant stream to form the at least partially condensed boil-off gas stream and the gaseous refrigerant stream, the two phase refrigerant stream comprising at least 90% nitrogen and having the gas phase portion and the liquid phase portion in the first heat exchanger.

Aspect 13: The method of any of Aspects 1-12, further comprising:

(n) before performing step (b), phase separating the at least partially condensed boil-off gas stream into a vapor stream and a liquid stream and performing step (b) on only the liquid stream.

Aspect 14: The method of any of Aspects 1-13, further comprising:

(o) pumping liquid natural gas from the storage tank through a spray header located in a vapor space of the storage tank.

Aspect 15: The method of any of Aspects 1-14, further comprising:

(p) controlling a position of a first valve as a function of a pressure of the gaseous refrigerant stream and a first set point, the first valve being positioned downstream from the first heat exchanger and upstream from the second heat exchanger and in fluid flow communication with the gaseous refrigerant stream; and

(q) setting the first set point as a function of a pressure of the storage tank.

Aspect 16: The method of Aspect 15, wherein step (q) further comprises setting the first set point as the function of the pressure of the storage tank and a power consumption of the compression system.

Aspect 17: The method of any of Aspects 1-16, further comprising:

(r) maintaining a difference between a temperature of the gaseous refrigerant stream before performing step (c) and a temperature of cooled refrigerant stream within a second predetermined range by controlling a position of an expansion valve located in fluid flow communication with the cooled refrigerant stream downstream from the second heat exchanger and upstream from the first heat exchanger.

Aspect 18: A boil-off gas re-condensation system comprising:

a first heat exchanger adapted to at least partially condense a boil-off gas stream withdrawn from a storage tank against a two phase refrigerant stream to produce a gaseous refrigerant stream that is returned to the storage tank and an at least partially condensed boil-off gas stream, the two phase refrigerant stream comprising no more than 5 mol % hydrocarbons and at least 90 mol % of one selected from the group of nitrogen and argon;

a second heat exchanger adapted to cool the gaseous refrigerant stream against a high pressure cooled refrigerant stream to form a warmed refrigerant stream;

a compression system having at least one compression stage adapted to compress the warmed refrigerant stream to form a compressed refrigerant stream and a third heat exchanger adapted to cool the compressed refrigerant stream to form a high pressure refrigerant stream;

an expander adapted to isentropically expand a second portion of the high pressure cooled refrigerant stream to form an expanded refrigerant stream that is in fluid flow communication with the gaseous refrigerant stream; and

a valve adapted to enable a first portion of the high pressure cooled refrigerant stream to expand to form the two phase refrigerant stream.

Aspect 19: The system of Aspect 18, wherein the first heat exchanger is adapted to at least partially condense the boil-off gas stream at a substantially constant temperature.

Aspect 20: The system of any of Aspects 18-19, wherein the system is adapted to maintain the boil-off gas at a pressure that is no more than 110% of a pressure of the storage tank from the point at which the boil-off gas is withdrawn from the storage tank as the boil-off gas stream to the point at which the boil-off gas is returned to the storage tank as the at least partially condensed boil-off gas stream.

Aspect 21: The system of any of Aspects 18-20, wherein the first heat exchanger comprises an inner vessel in fluid flow communication with the boil-off gas stream and an outer vessel in fluid flow communication with the two phase refrigerant stream, the inner vessel being contained within the outer vessel.

Aspect 22: The system of any of Aspects 18-21, further comprising at least one controller adapted to set a position of a first valve as a function of a pressure of the gaseous refrigerant stream and a first set point, the first valve being positioned downstream the first heat exchanger and upstream from the second heat exchanger and in fluid flow communication with the gaseous refrigerant stream, the first set point being a function of a pressure of the storage tank.

Aspect 23: The system of any of Aspects 18-22, wherein the at least one controller is further adapted to maintain a difference between a temperature of the gaseous refrigerant stream and a temperature of cooled refrigerant stream within a second predetermined range by controlling a position of an expansion valve located in fluid flow communication with the cooled refrigerant stream downstream from the second heat exchanger and upstream from the first heat exchanger.

### BRIEF DESCRIPTION OF DRAWINGS

FIG. 1 is a schematic flow diagram of a first exemplary BOG recondensation system for an LNG storage tank;

FIG. 2 is a schematic flow diagram of a second exemplary BOG recondensation system for an LNG storage tank;

FIG. 3 is a schematic flow diagram of a third exemplary BOG recondensation system for an LNG storage tank, in which the BOG stream is predominantly methane;

FIG. 4 is a schematic flow diagram of a fourth exemplary BOG recondensation system for an LNG storage tank, in which the BOG stream is predominantly methane;

FIG. 5 is is a schematic flow diagram showing exemplary controls used with the BOG recondensation system of FIG. 1; and

FIG. 6 is a schematic flow diagram of a fifth exemplary BOG recondensation system for an LNG storage tank.

### DETAILED DESCRIPTION

The ensuing detailed description provides preferred exemplary embodiments only, and is not intended to limit the scope, applicability, or configuration thereof. Rather, the ensuing detailed description of the preferred exemplary embodiments will provide those skilled in the art with an enabling description for implementing the preferred exemplary embodiments. Various changes may be made in the function and arrangement of elements without departing from the spirit and scope thereof.

Reference numerals that are introduced in the specification in association with a drawing figure may be repeated in one or more subsequent figures without additional description in the specification in order to provide context for other features.

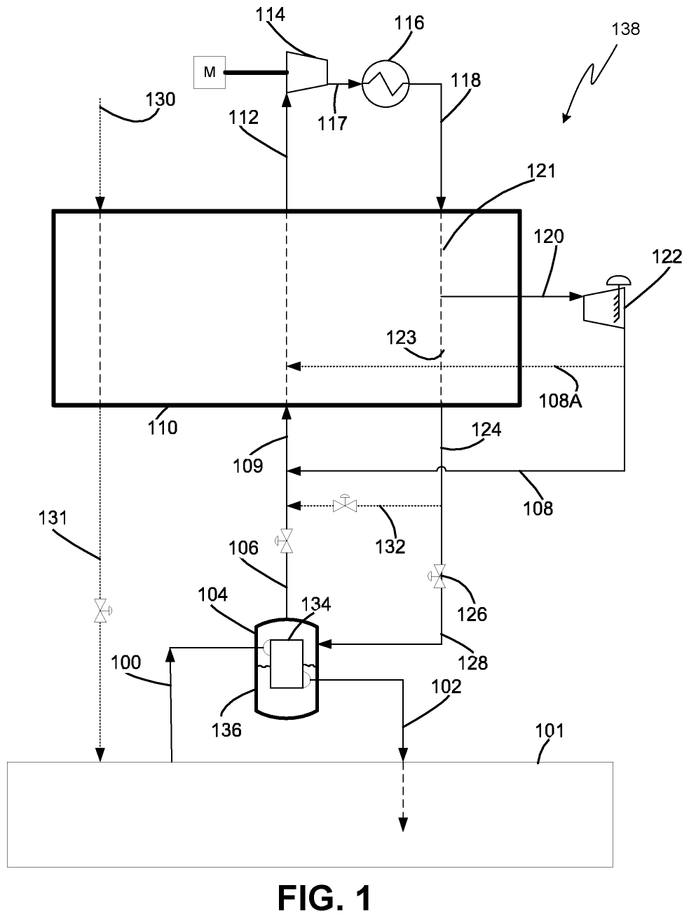

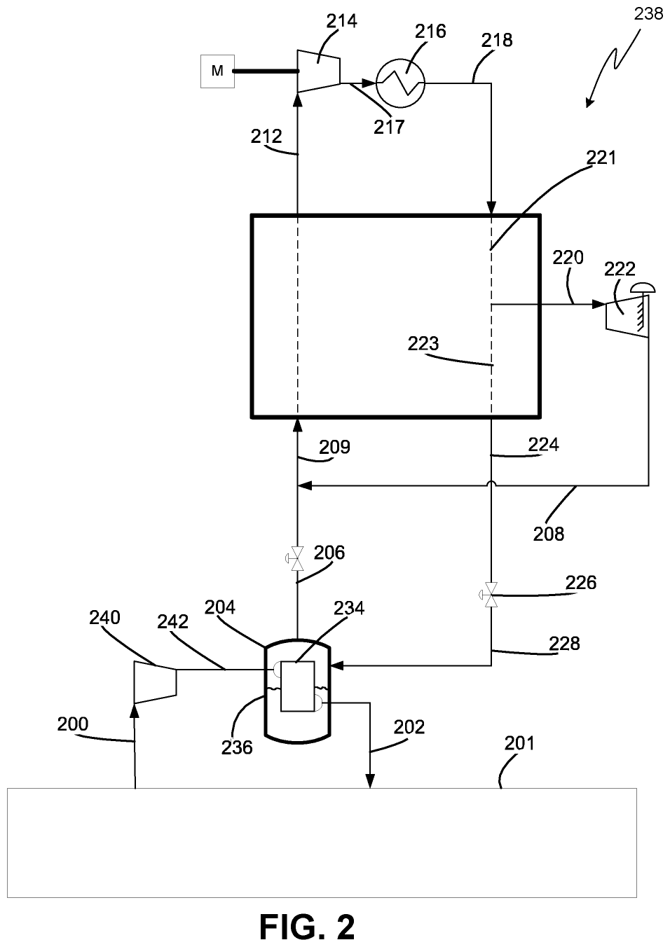

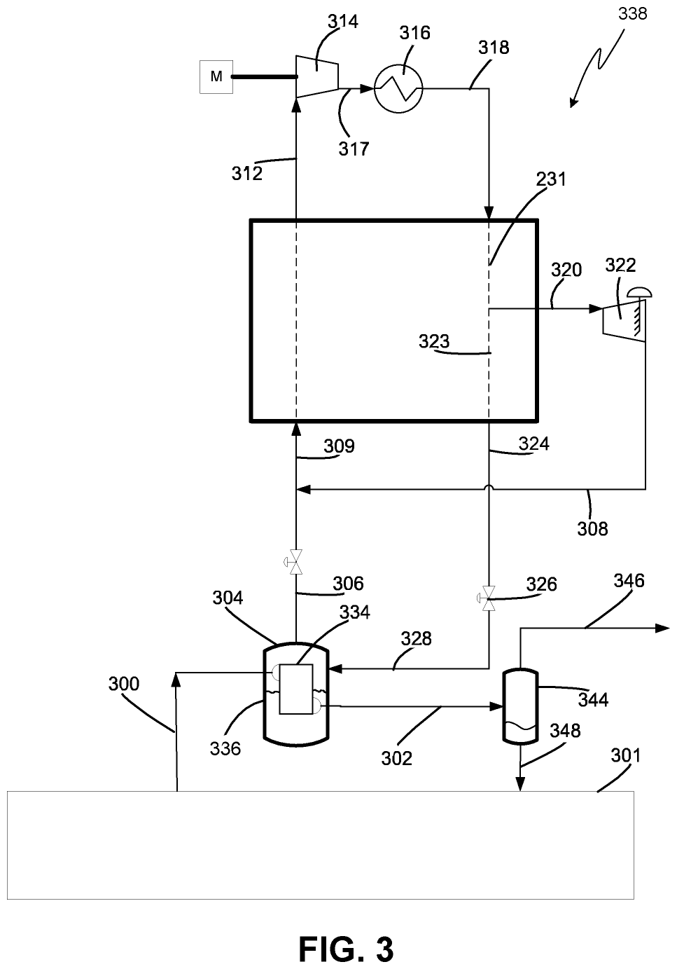

The application includes a plurality of exemplary embodiments. Features that are present in more than one embodiment are represented by reference numerals that differ by a factor of 100. For example, the storage tank 101 of the embodiment of FIG. 1 corresponds to the storage tank 201 of FIG. 2 and the storage tank 301 of FIG. 3. Unless a feature is specifically described as being different from other embodiments in which it is shown in the drawings, that feature can be assumed to have the same structure and function as the corresponding feature in the embodiment in which it is described. Moreover, if that feature does not have a different structure or function in a subsequently-described embodiment, it may not be specifically referred to in the specification.

The term “fluid flow communication,” as used in the specification and claims, refers to the nature of connectivity between two or more components that enables liquids, vapors, and/or two-phase mixtures to be transported between the components in a controlled fashion (i.e., without leakage) either directly or indirectly. Coupling two or more components such that they are in fluid flow communication with each other can involve any suitable method known in the art, such as with the use of welds, flanged conduits, gaskets, and bolts. Two or more components may also be coupled together via other components of the system that may separate them, for example, valves, gates, or other devices that may selectively restrict or direct fluid flow.

The term “conduit,” as used in the specification and claims, refers to one or more structures through which fluids can be transported between two or more components of a system. For example, conduits can include pipes, ducts, passageways, and combinations thereof that transport liquids, vapors, and/or gases.

The term “natural gas”, as used in the specification and claims, means a hydrocarbon gas mixture consisting primarily of methane.

The terms “hydrocarbon”, “hydrocarbon gas”, or “hydrocarbon fluid”, as used in the specification and claims, mean a gas/fluid comprising at least one hydrocarbon and for which such hydrocarbon(s) comprise at least 80%, and more preferably at least 90% of the overall composition of the gas/fluid.

In the claims, letters are used to identify claimed steps (e.g. (a), (b), and (c)). These letters are used to aid in referring to the method steps and are not intended to indicate the order in which claimed steps are performed, unless and only to the extent that such order is specifically recited in the claims.

Directional terms may be used in the specification and claims (e.g., upper, lower, left, right, etc.). These directional terms are merely intended to assist in describing exemplary embodiments, and are not intended to limit the scope thereof. As used herein, the term “upstream” is intended to mean in a direction that is opposite the direction of flow of a fluid in a conduit from a point of reference. Similarly, the term “downstream” is intended to mean in a direction that is the same as the direction of flow of a fluid in a conduit from a point of reference.

As used in the specification and claims, the terms “high-high”, “high”, “medium”, “low”, and “low-low” are intended to express relative values for a property of the elements with which these terms are used. For example, a high-high pressure stream is intended to indicate a stream having a higher pressure than the corresponding high pressure stream or medium pressure stream or low pressure stream described or claimed in this application. Similarly, a high pressure stream is intended to indicate a stream having a higher pressure than the corresponding medium pressure stream or low pressure stream described in the specification or claims, but lower than the corresponding high-high pressure stream described or claimed in this application. Similarly, a medium pressure stream is intended to indicate a stream having a higher pressure than the corresponding low pressure stream described in the specification or claims, but lower than the corresponding high pressure stream described or claimed in this application.

Unless otherwise stated herein, any and all percentages identified in the specification, drawings and claims should be understood to be on a weight percentage basis. Unless otherwise stated herein, any and all pressures identified in the specification, drawings and claims should be understood to mean gauge pressure.

As used in the specification and claims, the term “compression system” is defined as one or more compression stages. For example, a compression system may comprise multiple compression stages within a single compressor. In an alternative example, a compression system may comprise multiple compressors.

Unless otherwise stated herein, introducing a stream at a location is intended to mean introducing substantially all of the stream at the location. All streams discussed in the specification and shown in the drawings (typically represented by a line with an arrow showing the overall direction of fluid flow during normal operation) should be understood to be contained within a corresponding conduit. Each conduit should be understood to have at least one inlet and at least one outlet. Further, each piece of equipment should be understood to have at least one inlet and at least one outlet.

FIG. 1 shows an exemplary embodiment of a boil-off gas (BOG) re-condensing system 138 in which LNG is contained with in a storage tank 101. Boil-off gas exits the storage tank 101 as a BOG stream 100, which flows through a condensing heat exchanger 104 and is at least partly condensed, forming partially condensed BOG stream 102, which is returned to the storage tank 101 by gravity, either to the top of the tank if partially condensed or near the bottom if fully condensed.

In this embodiment, the condensing heat exchanger 104 is a plate fin heat exchanger 134 located within in a vessel 136 containing boiling liquid nitrogen (LIN). In this embodiment, the condensing heat exchanger 104 is located above the storage tank 101. Alternatively, the condensing heat exchanger 104 could be located inside the storage tank 101, for example, on the surface of a heat exchanging coil containing boiling LIN.

A gaseous nitrogen (GAN) stream 106 is withdrawn from the condensing heat exchanger 104 and combined with an expanded GAN stream 108 to form a combined GAN stream 109. The combined GAN stream 109 is warmed to near ambient temperature in a heat exchanger 110 against a high pressure GAN stream 118 (described herein), forming a warmed GAN stream 112. Alternatively, the expanded GAN stream 108 could be combined with the GAN stream 106 after GAN stream 106 has been partly warmed in the heat exchanger 110. This is depicted by the broken line representing the alternate expanded GAN stream 108A.

The warmed GAN stream 112 is then compressed in a compressor 114 to form a compressed GAN stream 117. The compressed GAN stream 117 is then is cooled to near ambient temperature against cooling water or ambient air (not shown) in a heat exchanger 116 to form a high pressure GAN stream 118. Compressor 114 could optionally include multiple stages of compression with cooling water or air intercoolers (not shown).

The high pressure GAN stream 118 is cooled in the heat exchanger 110 against the combined GAN stream 109 to an intermediate temperature to form a high pressure cooled GAN stream 121. A portion 120 of the high pressure cooled GAN stream 121 is then expanded isentropically in an expander 122. Work produced by the expander 122 may be recovered as electrical energy in a generator, or the expander 122 could be mechanically coupled to the compressor 114 to provide part of the compression energy required to press the warmed GAN stream 112.

The remaining portion 123 of the high pressure cooled GAN stream 121 is then further cooled in heat exchanger 110 exiting as a cooled GAN stream 124, which has a temperature slightly warmer than the GAN stream 106. The cooled GAN stream 124 is flashed across a JT valve 126, forming two phase nitrogen stream 128, which is fed to the shell side of the condensing heat exchanger 104.

In this embodiment, the refrigeration duty for condensation of the BOG stream 100 is provided by nitrogen. In other embodiments, alternate refrigerants could be used, such as argon for example. It is preferable that the refrigerant comprise less than 5 mol % hydrocarbons. This improves safety by using a non-flammable refrigerant in portions of the system 138 that are operated under an elevated pressure. It is also preferable that the refrigerant have a purity of at least 90 mol % and, more preferably, at least 99%. For example, if the refrigerant is nitrogen, then it comprises preferably at least 90 mol % nitrogen. The preferred purity of the refrigerant enables the boiling of the refrigerant in the condensing heat exchanger 104 and compression of the refrigerant in the compression system 114 to be performed more efficiently.

In this embodiment, the condensation of the BOG stream 100 is performed at a substantially constant temperature. In this context, “substantially constant temperature” means that the temperature difference between the BOG stream 100 as it enters the condensing heat exchanger 104 and the partially condensed BOG stream 102 as it exits the condensing heat exchanger is preferably less than 2 degrees Celsius.

The heat exchanger 110 may also be used to condense a warm natural gas stream 130 to form a condensed natural gas stream 131. In addition, a supplemental LIN refrigeration stream 132 could optionally be directed to the cold end of the condensing heat exchanger 104.

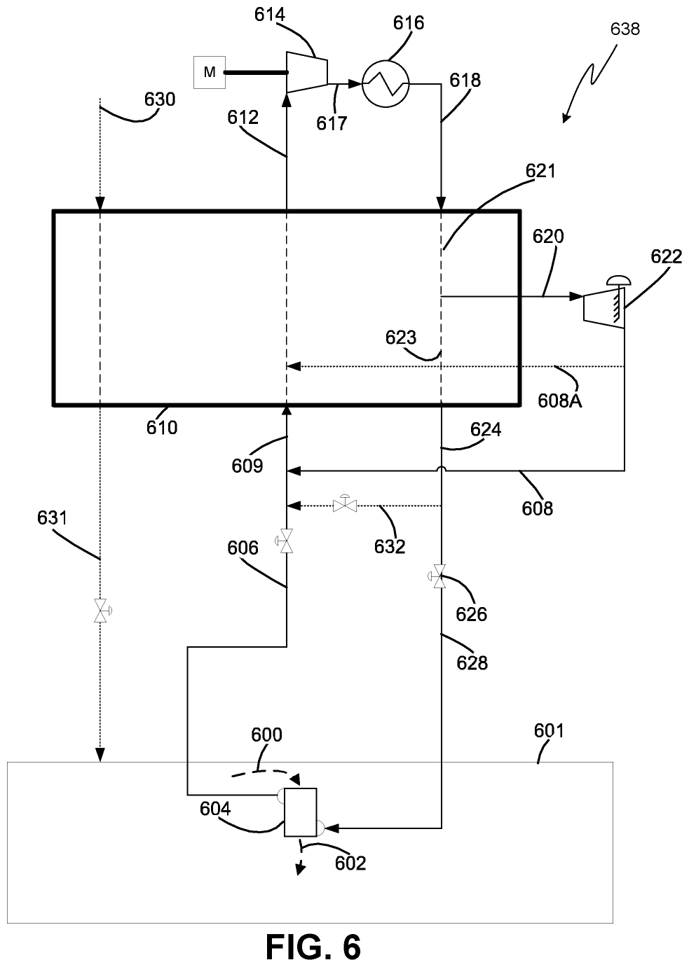

FIG. 6 shows another exemplary embodiment of the BOG re-condensing system 638, which the condensing heat exchanger is located within the head space of the storage tank 601. In this embodiment, the two phase nitrogen stream 128 is circulated through a heat exchanging coil 604 located in the head space of the storage tank 601. BOG in the head space (represented by dashed line 600) comes in contact with the outer surface of the heat exchanging coil 604, becomes at least partially condensed (represented by dashed line 602), a flows downwardly away from the heat exchanging coil 604.

FIG. 2 shows another exemplary embodiment of the BOG re-condensing system 238, in which a blower 240 is used to overcome the frictional resistance of the piping and the condensing heat exchanger 204. The blower 240 conveys a BOG stream 242 to the condensing heat exchanger 204, where it is at least partly condensed. In this embodiment, some sensible cooling of the BOG occurs in the condensing heat exchanger 204, but all of the cooling of the BOG stream 242 is still provided by boiling liquid nitrogen, in contrast with the prior art.

It is important to note that, even in the embodiment shown in FIG. 2, the BOG remains substantially at the pressure of the storage tank 101 throughout the re-liquification process. In this context, the term “substantially” means that the pressure of the BOG is only elevated to the extent required to overcome friction losses incurred as it circulates through the condensing heat exchanger 104 and the conduits that contain the BOG stream 100 and the partially condensed BOG stream 102. Stated another way, the BOG is preferably maintained at a pressure that is no more than 150%, more preferably no more than 120%, and most preferably no more than 105%, of the pressure of the storage tank 101. For example, it is common for the pressure of a bulk LNG storage tank to be maintained at slightly above atmospheric pressure of 14.7 PSIA (101.4 kPa). Based on a tank pressure of 15 PSIA (103.4 kPa), it is preferable that the re-condensation process be performed on the BOG at a pressure that does not exceed 18 PSIA (124.1 kPa) at any time during the process (i.e., from point at which the BOG stream 200 is withdrawn from the storage tank 301 to the point at which the partially condensed BOG stream 302 reenters the storage tank 301). Among other advantages, this enables the portion of the system 338 through which flammable fluid circulates to operate at low pressure, which reduces the risk of a flammable leak.

FIG. 3 shows another exemplary embodiment of the BOG re-condensing system 338, which is useful when the BOG stream 300 contains a substantial nitrogen fraction (e.g., more than 10 mol % nitrogen). When the BOG stream 300 contains a substantial nitrogen fraction, it is more efficient to provide the required cooling duty by only partly condensing it. The partially condensed BOG stream 302 is separated into a liquid stream 348 and vapor stream 346 in phase separator 344. The liquid stream 348 is returned to the storage tank 301 and vapor stream 346 (which is nitrogen rich) may be burned or used as fuel.

For storage tanks 301 in which the LNG contains a substantial nitrogen fraction, the exemplary embodiment shown in FIG. 3 is useful because it prevents uncondensed nitrogen from accumulating in the vapor space of the storage tank 301. If nitrogen accumulates in the vapor space, the temperature of the BOG stream 300 decreases. This decreased temperature increases the power required for condensation of the BOG stream 300 and may decrease the capacity of the BOG re-condensing system 338. For condensation of BOG on an LNG transport ship, increased nitrogen levels in the BOG stream 300 may also negatively impact the ship engines that use BOG as fuel.

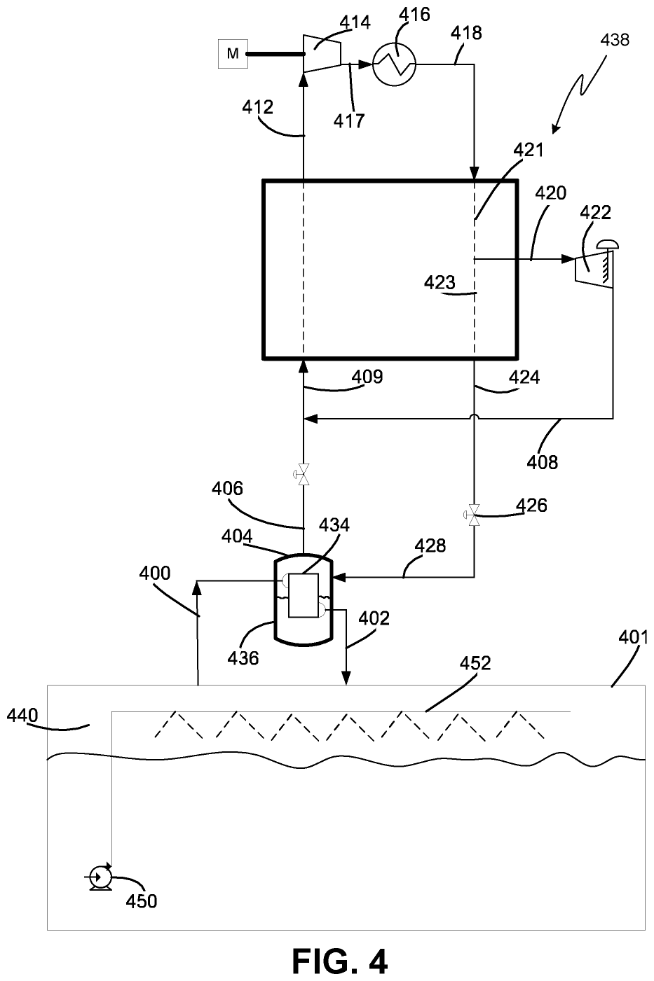

FIG. 4 shows another exemplary embodiment of a BOG re-condensing system 438, which is also useful when the BOG stream 400 contains nitrogen. In this case, the partially condensed gas stream 402 is only partly condensed and returned to the top of the storage tank 401 in its vapor space 440. In order to prevent nitrogen from accumulating in the vapor space 440, a pump 450 is used to feed LNG to a spray header 452, which keeps the liquid and vapor phases in equilibrium and prevents the accumulation or enrichment of nitrogen in the vapor space 440. For LNG carrier ships, the pump 450 and spray header 452 are often needed for cool-down of the storage tank 101 prior to initial filling of the tank. Accordingly, the same pump 450 and spray header 452 may be used for both purposes.

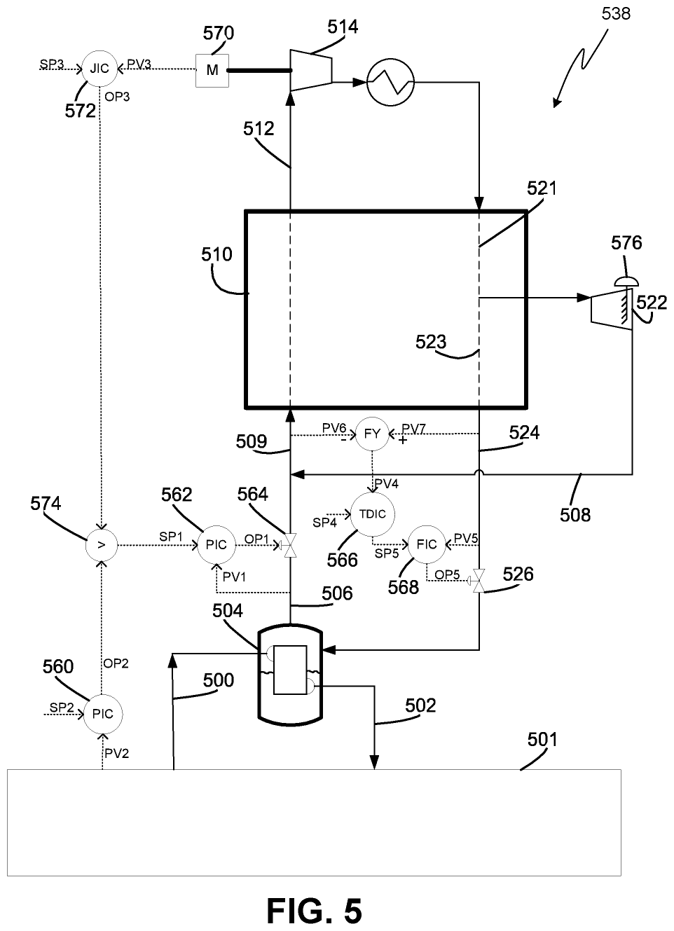

Another exemplary embodiment of the BOG re-condensing system 538 is shown in FIG. 5. In this embodiment, a valve controller 562 is used to indirectly control pressure in the storage tank 501 by modulating the capacity of the condensing heat exchanger 504. The pressure controller 560 controls the pressure in the storage tank 501 by adjusting the setpoint SP1 of the valve controller 562 based on an output OP1 of a pressure controller 560, which in turn controls the pressure of boiling LIN in the condensing heat exchanger 504 by manipulating valve 564. As used herein, the terms “closing” and “opening” are intended to mean changing the position of a valve in one direction or another—not necessarily to change the valve position to a fully open or fully closed position.

When the boil-off rate is at the design capacity of the BOG re-condensing system 538, the pressure of the storage tank 501 (measured by PV2) is at the setpoint SP2 and valve 564 is fully or nearly fully open. If the boil-off rate decreases below the design capacity, the pressure in the storage tank 501 will begin to fall and the pressure controller 560 will respond by increasing the setpoint SP1 to the valve controller 562, which will respond by partly closing valve 564, thereby increasing the pressure of the boiling LIN and in turn increasing the LIN temperature which decreases the driving force for heat transfer and the cooling duty so that the tank pressure is maintained at the setpoint. The pressures downstream of 564 and upstream of the JT valve 526 drop because the valve is closing and the mass flowrate of nitrogen is decreasing, while the volumetric flowrate remains roughly the same, allowing compressor 514 to continue to operate at or near peak efficiency. The liquid level in the condensing heat exchanger 504 increases because the inventory of gaseous nitrogen in the system decreases due to the reduced pressures on both the suction and discharge circuits connected to 514, and in heat exchanger 510. This method of turndown reduces the mass flowrate and power consumption of the compressor 514 by reducing system gaseous inventory without loss of nitrogen refrigerant.

Conversely, if the boil-off rate increases, the pressure controller 560 will respond by increasing the setpoint to the valve controller 562, which will respond by opening valve 564, thereby increasing the pressure of the boiling LIN and decreasing the temperature of the LIN which increases the driving force for heat transfer and the cooling duty so that the storage tank 501 pressure is maintained at the setpoint SP2. The liquid level in 504 then decreases, bringing additional nitrogen inventory into circulation and raising the pressures in the system downstream of valve 564 and upstream of the JT valve 526.

As mentioned previously, the output OP2 of the pressure controller 560 is normally used as the setpoint SP1 of the valve controller 562. At boil-off rates above the design point, the cooling duty may be such that the power needed approaches the maximum power available from the motor 570 used to drive the compressor 514. To prevent motor overload, a power controller 572 is provided. The power controller 572 compares the power consumption of the motor PV3 to the user supplied setpoint SP3 (the maximum allowed power). If the boil-off rate is high and the power consumption PV3 approaches the setpoint SP3, the output OP3 from power controller 572 increases. This output OP3 is compared to the output OP2 from the pressure controller 560 in a selector block 574, which passes the larger value as a setpoint SP1 to the valve controller 562. If the output OP3 from the power controller 572 is greater than the output OP2 from the pressure controller 560, the power controller output OP3 will override the pressure controller output OP2 to prevent overload of the motor 570. In that case, the pressure in the storage tank 501 will exceed the setpoint SP2 and may activate pressure relief valves (not shown) and send excess BOG to flare or vent.

Another feature of the control system is to maintain a constant temperature difference between the temperatures of the combined GAN stream 109 entering the cold end of the heat exchanger 510 (measured at PV6) and the cooled GAN stream 524 exiting the cold end of the heat exchanger 510 (measured at PV7). This temperature difference PV4 is measured by FY and fed by signal PV4 to a temperature difference controller 566. The temperature difference controller 566 maintains the temperature difference PV4 at an operator supplied setpoint SP4 by manipulating the setpoint SP5 of a flow controller 568. The flow controller 568, in turn, controls the position of the JT valve, which controls the flow rate of nitrogen through the JT valve 526. If the temperature difference PV4 at the cold end of the heat exchanger 510 begins to exceed the setpoint SP4, the temperature difference controller 566 will decrease the setpoint SP5 to the flow controller 568. The flow controller 568 will, in turn, begin to close the JT valve 526, reducing the flow of the cooled GAN stream 524 which will reduce the temperature difference PV4.

In this exemplary embodiment, the expander 522 is equipped with flow control nozzles 576 that can be adjusted manually to change the flowrate and the outlet-inlet pressure difference across the expander 522 and the compressor 514 to improve efficiency.

### EXAMPLE 1

Table 1 shows stream data for an example of a process conducted in accordance with the system of FIG. 1, but without the warm natural gas stream 130, alternate expanded GAN stream 108A, or the supplemental LIN refrigeration stream 132. In this example, the total compression work of the compressor 114 is 2,252 hp and the work produced by the expander 122 is 309 hp for a net work requirement of 1,943 hp. The cooling duty of the condensing heat exchanger 104 is 311 kw in this example.

TABLE 1

| Stream | 100 | 102 | 106 | 108 | 112 | 118 | 120 | 124 | 128 | |
|---|---|---|---|---|---|---|---|---|---|---|
| Temperature | −258 | −258 | −262 | −229 | 74 | 79 | −125 | −238 | −262 | F. |
| Pressure | 15 | 15 | 208 | 208 | 200 | 883 | 881 | 879 | 208 | psia |
| Vapor Fraction | 1.00 | 0.00 | 1.00 | 1.00 | 1.00 | 1.00 | 1.00 | 0.00 | 0.24 | |
| Mole Flows | 302 | 302 | 858 | 1666 | 2524 | 2524 | 1666 | 858 | 858 | lbmol/hr |
| Mass Flows | 4850 | 4850 | 24031 | 46669 | 70700 | 70700 | 46669 | 24031 | 24031 | lb/hr |
| Mole Fractions | | | | | | | | | | |
| N2 | 0 | 0 | 1 | 1 | 1 | 1 | 1 | 1 | 1 | |
| C1 | 1 | 1 | 0 | 0 | 0 | 0 | 0 | 0 | 0 | |

The present invention has been disclosed in terms of preferred embodiments and alternate embodiments thereof. Of course, various changes, modifications, and alterations from the teachings of the present invention may be contemplated by those skilled in the art without departing from the intended spirit and scope thereof. It is intended that the present invention only be limited by the terms of the appended claims.

1. A method for re-condensing a boil-off gas stream comprising natural gas from a storage tank, the method comprising:
(a) at least partially condensing the boil-off gas stream in a first heat exchanger against a two phase refrigerant stream to form an at least partially condensed boil-off gas stream and a gaseous refrigerant stream, the two phase refrigerant stream comprising no more than 5 mol % hydrocarbons and at least 90 mol % of at least one selected from the group of nitrogen and argon, the two-phase refrigerant stream having a gas phase portion and a liquid phase portion in the first heat exchanger;
(b) returning the at least partially condensed boil-off gas stream to the storage tank;
(c) heating the gaseous refrigerant stream in a second heat exchanger against a high pressure refrigerant stream to form a warmed refrigerant stream;
(d) compressing the warmed refrigerant stream in a compression system to form a compressed refrigerant stream;
(e) cooling the compressed refrigerant stream in a third heat exchanger to form the high pressure refrigerant stream;
(f) cooling the high pressure refrigerant stream against the gaseous refrigerant stream in the second heat exchanger to form a high pressure cooled refrigerant stream;
(g) separating the high pressure cooled refrigerant stream into a first portion and a second portion;
(h) expanding the second portion of the high pressure cooled refrigerant stream to form an expanded refrigerant stream.

2. The method of claim 1, further comprising:
(i) combining the expanded refrigerant stream with the gaseous refrigerant stream before performing at least a portion of step (c).

3. The method of claim 2, wherein step (i) further comprises combining the expanded refrigerant stream with the gaseous refrigerant stream and a portion of the cooled refrigerant stream before performing step (c).

4. The method of claim 1, wherein step (a) further comprises at least partially condensing the boil-off gas stream in the first heat exchanger at a substantially constant temperature against the two phase refrigerant stream to form the at least partially condensed boil-off gas stream and the gaseous refrigerant stream.

5. The method of claim 1, further comprising:
(j) maintaining the boil-off gas at a pressure that is no more than 110% of a pressure of the storage tank during the performance of steps (a) and (b).

6. The method of claim 1, wherein step (a) further comprises at least partially condensing the boil-off gas stream in a first vessel of the first heat exchanger against the two phase refrigerant stream flowing through a second vessel to form the at least partially condensed boil-off gas stream and the gaseous refrigerant stream, the first vessel being contained within the second vessel.

7. The method of claim 1, wherein the two phase refrigerant stream comprises at least 99% nitrogen.

8. The method of claim 1, wherein step (i) comprises
(i) combining the expanded refrigerant stream with the gaseous refrigerant stream after a portion of the cooling of step (c) has been performed on the gaseous refrigerant stream.

9. The method of claim 1, further comprising:
(l) condensing a natural gas stream against the gaseous refrigerant stream in the second heat exchanger.

10. The method of claim 1, further comprising:
(m) providing a blower that results in increased flow of the boil-off gas stream through the condensing heat exchanger.

11. The method of claim 1, further comprising:
(n) before performing step (b), phase separating the at least partially condensed boil-off gas stream into a vapor stream and a liquid stream and performing step (b) on only the liquid stream.

12. The method of claim 1, further comprising:
(p) controlling a position of a first valve as a function of a pressure of the gaseous refrigerant stream and a first set point, the first valve being positioned downstream from the first heat exchanger and upstream from the second heat exchanger and in fluid flow communication with the gaseous refrigerant stream; and
(q) setting the first set point as a function of a pressure of the storage tank.

13. The method of claim 12, wherein step (q) further comprises setting the first set point as the function of the pressure of the storage tank and a power consumption of the compression system.

14. The method of claim 1, further comprising:
(r) maintaining a difference between a temperature of the gaseous refrigerant stream before performing step (c) and a temperature of cooled refrigerant stream within a second predetermined range by controlling a position of an expansion valve located in fluid flow communication with the cooled refrigerant stream downstream from the second heat exchanger and upstream from the first heat exchanger.

15. A boil-off gas re-condensation system comprising:
a first heat exchanger adapted to at least partially condense a boil-off gas stream withdrawn from a storage tank against a two phase refrigerant stream to produce a gaseous refrigerant stream that is returned to the storage tank and an at least partially condensed boil-off gas stream, the two phase refrigerant stream comprising no more than 5 mol % hydrocarbons and at least 90 mol % of one selected from the group of nitrogen and argon;
a second heat exchanger adapted to cool the gaseous refrigerant stream against a high pressure cooled refrigerant stream to form a warmed refrigerant stream;
a compression system having at least one compression stage adapted to compress the warmed refrigerant stream to form a compressed refrigerant stream and a third heat exchanger adapted to cool the compressed refrigerant stream to form a high pressure refrigerant stream;
an expander adapted to isentropically expand a second portion of the high pressure cooled refrigerant stream to form an expanded refrigerant stream that is in fluid flow communication with the gaseous refrigerant stream; and
a valve adapted to enable a first portion of the high pressure cooled refrigerant stream to expand to form the two phase refrigerant stream.

16. The system of claim 15, wherein the first heat exchanger is adapted to at least partially condense the boil-off gas stream at a substantially constant temperature.

17. The system of claim 15, wherein the system is adapted to maintain the boil-off gas at a pressure that is no more than 110% of a pressure of the storage tank from the point at which the boil-off gas is withdrawn from the storage tank as the boil-off gas stream to the point at which the boil-off gas is returned to the storage tank as the at least partially condensed boil-off gas stream.

18. The system of claim 15, wherein the first heat exchanger comprises an inner vessel in fluid flow communication with the boil-off gas stream and an outer vessel in fluid flow communication with the two phase refrigerant stream, the inner vessel being contained within the outer vessel.

19. The system of claim 15, further comprising at least one controller adapted to set a position of a first valve as a function of a pressure of the gaseous refrigerant stream and a first set point, the first valve being positioned downstream the first heat exchanger and upstream from the second heat exchanger and in fluid flow communication with the gaseous refrigerant stream, the first set point being a function of a pressure of the storage tank.

20. The system of claim 15, wherein the at least one controller is further adapted to maintain a difference between a temperature of the gaseous refrigerant stream and a temperature of cooled refrigerant stream within a second predetermined range by controlling a position of an expansion valve located in fluid flow communication with the cooled refrigerant stream downstream from the second heat exchanger and upstream from the first heat exchanger.
